(19) United States
(12) Patent Application Publication
(10) Pub. No.: US 2014/0012729 A1
(43) Pub. Date: Jan. 9, 2014

(54) Equitized Currency Trust for Real-Time Currency Trading

(71) Applicant: M7 Ventures, LLC, Bedminster, NJ (US)

(72) Inventor: Daniel Joseph McCabe, Upper Saddle River, NJ (US)

(73) Assignee: M7 Ventures, LLC, Bedminster, NJ (US)

(21) Appl. No.: 13/971,656

(22) Filed: Aug. 20, 2013

Related U.S. Application Data
(63) Continuation of application No. 13/416,060, filed on Mar. 9, 2012.
Application No. 13/416,060 is a continuation of application No. 12/432,729, filed on Apr. 29, 2009, now abandoned.
Application No. 12/432,729 is a continuation of application No. 10/960,039, filed on Oct. 8, 2004, now abandoned.

(51) Int. Cl. G06Q 40/04

(52) U.S. Cl. CPC G06Q 40/04
USPC 705/37

(57) ABSTRACT

An equitized currency trust has its underlying value based solely on currency, rather than on securities and/or commodities. Shares of the equitized currency trust are priced in a currency other than the currency that forms the underlying value.

### CROSS REFERENCE TO RELATED PATENT APPLICATIONS

This application claims priority under 35 USC §120 as a continuation application of U.S. application Ser. No. 13/416,060, filed Mar. 9, 2012, entitled “Equitized Currency Trust for Real-Time Currency Trading”, which is a continuation of patent application Ser. No. 12/432,729, filed on Apr. 29, 2009, entitled “Equitized Currency Trust for Real-Time Currency Trading”, which is a continuation of patent application Ser. No. 10/960,039, filed on Oct. 8, 2004, entitled “Equitized Currency Trust for Real-Time Currency Trading,” now abandoned, all of which are assigned to the assignee of the present application and are incorporated herein by reference.

### BACKGROUND OF THE INVENTION

The present invention relates to a marketplace for investing in a currency. More particularly, it concerns securitizing currency by creating an associated financial instrument representing an ownership interest in a trust that is backed by currency.

### SUMMARY OF THE INVENTION

In one aspect, the present invention is directed to an equitized currency trust whose underlying value is based solely on currency.

In another aspect, the present invention is directed to a share, or other financial instrument, representing an exchangeable ownership interest in such an equitized currency trust. While the underlying value of the equitized currency trust is in a first currency, a price of a share of the equitized currency trust is in a second currency different from the first currency.

In still another aspect, the present invention is directed to an equitized currency trust whose underlying value is based on a plurality of currencies.

In still another aspect, the present invention is directed to options and futures in such a share or other financial instrument. While the underlying value of the equitized currency trust is solely in a first currency, a price of an option on one or more shares of the equitized currency trust is in a second currency different from the first currency. Similarly, a price of a future on one or more shares of the equitized currency trust is in a second currency different from the first currency.

In yet another aspect, the present invention is directed to a method of creating an equitized currency trust in accordance with the present invention. The method comprises arranging for a securities exchange to list shares in the trust, once the trust has been created; and selling shares in the trust to one or more underwriters in exchange for units of a first currency, each share representing an ownership interest in a plurality of units of the first currency, and being priced in a second currency that is different from the first currency.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 shows an embodiment of the present invention wherein the trust is created.

### DETAILED DESCRIPTION OF PREFERRED EMBODIMENT

The present invention contemplates the formation of an equitized trust whose underlying value is only in currency. In the present invention, the trust is “equitized” in the sense that a tradable equity may be formed to represent an ownership interest in the trust.

In one embodiment, the underlying currency is different from that in which the corresponding shares are priced (and thus quoted, bought and sold). Thus, as an example, if the trust is backed by Euros, it may be traded in U.S. dollars. Such an equitized currency trust allows one to quickly enter and exit the market when investing in Euros. In this embodiment, it is typically the case that the currency underlying the value of the trust is different from a second currency of the country in which shares of the trust are traded on a securities exchange—e.g., a trust backed by Euros has its shares traded on a securities exchange in the U.S., where dollars (a ‘second’ currency), rather than Euros, are commonly used. It is understood that such a trust can be backed by any currency, and its shares traded in any country where that currency is not used.

In another embodiment, the underlying currency is the same as that in which the corresponding shares are priced. Thus, as an example, if the trust is backed by U.S. dollars, it may be traded in U.S. dollars. Income from shares in such an equitized currency trust may be treated as dividends, rather than interest if the Bank were to lend out the funds.

### EXAMPLE

In the following example, it is assumed that a trust in accordance with the present invention has its underlying value in Euros (“Fx_Euro” Trust), its corresponding shares priced (both quoted and traded) in US dollars, the shares being traded on a particular securities exchange.

Creation of Trust

Initially, an underwriter, such as an investment bank (“Bank”), creates the trust and arranges with the securities exchange for corresponding shares to be traded. The Bank may then sell shares in the trust to one more underwriters (“Authorized Participants” or “APs”) who, in exchange, give Euros to the Bank. Preferably, the Bank sells these shares in sizeable lots, such as 50,000 shares, 100,000 shares, or the like. Furthermore, each share may comprise a plurality of Euros—such as 10 or 100. Therefore, if the spot exchange rate is 1 Euro for US $1.22, then a single share comprising 100 Euros may be priced at about $122. This creates the trust.

Trading Shares in Trust

Preferably, redeeming the shares for Euros from the Bank may only be done by the underwriters and that, too, in sizeable quantities, such as those mentioned above. All others may buy and sell shares on the securities exchange using U.S. Dollars. If, for example, the U.S. Dollar is high relative to the Euro, one may purchase shares of such a trust in U.S. Dollars. Later on, after the U.S. Dollar has dropped relative to the Euro, that person may sell those shares for a gain, since the price of each share presumably would have increased, due to the decrease in value of the U.S. Dollar relative to the Euro.

Trading such shares in an equitized currency trust may have the advantages of (1) reduced transaction costs (lower ‘spread’) relative to buy and selling Euros from dealers, (2) increased speed at which such transactions may be conducted; (3) obviating the need to take physical custody of the Euros; and (4) providing an alternative to the currency derivatives market for less sophisticated investors and those prohibited from participating in such markets. Trading in such shares may also serve as a hedge against currency fluctuations.

It is understood that the underlying value of the trust may be in Japanese Yen, Chinese Yuan, Australian Dollars, British Pound Sterling, and a host of other currencies. Thus, a single securities exchange may list shares, priced in U.S. Dollars, for a plurality of such trusts, each backed by one of these currencies.

In another embodiment, the trust may be backed by differing amounts of a plurality of currencies. Such a trust may comprise equal U.S. Dollar-value amounts of the different currencies. Alternatively, it may be GDP-weighted, in which case the percentage amount of any one currency in the trust, is based on the proportion of the GDP of that country in the trust, relative to the combined GDP of all countries whose currencies are represented in the trust. Thus, trusts backed by a mix of currencies from a particular geographical region may be formed. The geographical region may be a continent. To create an “FX-Asia” trust, for example, the underwriters may have provided the Bank with a mix of Japanese Yen, Chinese Yuan, and Korean Won. Similarly, a Latin American trust, an Eastern European trust, etc. may also be formed, and their shares traded on an exchange.

The present invention also contemplates a market for options and futures for one or more shares formed in accordance with the present invention. An option preferably is priced in a second currency that is different from the first currency which forms the underlying value of the trust. Similarly, a future preferably is priced in a second currency that is different from the first currency which forms the underlying value of the trust. The mechanics of creating and trading options and futures of shares of an equitized currency trust are not unlike those for an exchange traded fund (albeit subject to different securities regulations), which are well understood by those skilled in the art, and so are not discussed here. And generally speaking, currency options and futures are also known to those skilled in the art, as exemplified by U.S. Published Patent Application No. 2004/0199442 A1, whose contents are incorporated by reference.

The details of the regulatory aspects of creating a new trust and marketing shares and other financial instruments representing an ownership interest in a trust are well known to those skilled in the art.

The hardware infrastructure, including the securities marketplace, to implement the present invention is already in the hands of the customers, investment banks, brokers, dealers, specialists, markets, and others, and so are not repeated here. One skilled in the art will also recognize that the logistics of establishing, issuing, listing and trading a new type of equity on an exchange is well understood. Therefore, it is believed that the underlying systems and procedures disclosed in U.S. Pat. No. 5,983,204, U.S. Pat. No. 5,950,176, U.S. Pat. No. 5,946,667, U.S. Pat. No. 5,806,048, all of whose contents are incorporated by reference to the extent necessary to understand the present invention, may be relevant to one or more facets of deploying the present invention.

Trading in shares or other financial instruments on an exchange is also well understood. An investor may contact another party, such as a broker, a dealer or a specialist, either in person or via some communications device, such as a telephone, computer or the like, to place an order to buy or sell a financial instrument established in accordance with the present invention. The party receiving the order will ultimately see to it that the appropriate trade is executed, using a known manner of trading, either by themselves or using intermediaries, and either in person, or via another communications device, also well known in the art.

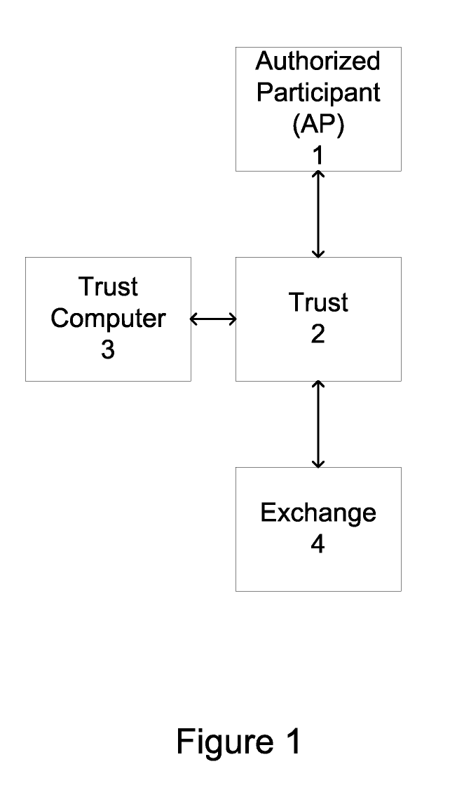

FIG. 1 shows an embodiment of the present invention wherein the trust is created. An AP 1 wishing to purchase shares of a trust communicates with the trust 2 to place an order for shares. Upon receipt of AP's order for shares of a trust, trust's computer 3 checks to see whether assets have been transferred to the trust 2. Once trust's computer 3 determines that assets have been transferred to the trust 2, trust's computer 3 generates a certificate. Trust's computer 3 then communicates the certificate to the AP 1 in any of a number of ways, including mail, electronic mail, modem, etc.

Finally, proof of ownership of the shares or other financial instrument of the present invention can take one of many forms. For instance, the financial instrument may be in the form of printed certificates held by the investor, printed certificates held in ‘street name’ by another in trust for the investor, in the form of an electronic record, preferably one that is digitally signed by a cognizant authority, or in any other form normally used in the securities industry. Regardless of how ownership is manifested, the financial instrument represents an ownership interest in the equitized currency trust of the present invention.

Although the present invention has been described to a certain degree of particularity, it should be understood that various alterations and modifications could be made without departing from the scope of the invention as hereinafter claimed.

1-11. (canceled)

12. A system for administering a financial instrument, the system comprising:
a computer system configured to coordinate with a securities exchange to trade shares of an equitized currency trust wherein an underlying value of the equitized currency trust is based solely on a plurality of currencies from a corresponding plurality of countries;
the computer system configured to price the shares of the equitized currency trust in a currency not contained in the plurality of currencies, and priced in the currency of the country in which the shares of the equitized currency trust are traded, and where each share of the equitized currency trust includes an integer number of units of the plurality of currencies;
wherein the computer system processes an order from an Authorized Participant for greater than 50,000 shares in exchange for the plurality of currencies, and wherein the computer system takes a directive from the Authorized Participant for redemption of greater than 50,000 shares in exchange for the plurality of currencies; and,
wherein the relative weight of the GDP of each country corresponding to each of the plurality of currencies determines the amount of each of the plurality of currencies in the equitized currency trust.

13. The system according to claim 12, wherein the plurality of currencies all correspond to countries belonging to the same continent.

14. The system of claim 12, wherein the computer system is further configured to coordinate with a securities exchange to trade an option on one or more shares of the equitized currency trust.

15. The system of claim 12, wherein the computer system is further configured to coordinate with a securities exchange to trade a future on one or more shares of the equitized currency trust.

16. A method of managing an equitized currency trust whose underlying value is based on a plurality of currencies from a corresponding plurality of countries, and whose shares are priced in a second currency different from the plurality of currencies, the method comprising:
exchanging, using a computer system, at least 50,000 shares in the equitized currency trust to one or more underwriters for integer units of the plurality of currencies, each share representing an ownership interest in a plurality of units of the plurality of currencies, and being priced in the second currency; and
receiving, with a computer system, a directive from the one or more underwriters for redemption of greater than 50,000 shares in exchange for the plurality of currencies.

17. A method for administering a financial instrument, the method comprising:
listing with a securities exchange shares of an equitized currency trust wherein an underlying value of the equitized currency trust is based solely on a plurality of currencies from a corresponding plurality of countries, and where the shares of the equitized currency trust are priced in a currency not contained in the plurality of currencies, and priced in the currency of the country in which the shares of the equitized currency trust are traded, and where each share of the equitized currency trust includes an integer number of units of the plurality of currencies and wherein the relative weight of the GDP of each country corresponding to each of the plurality of currencies determines the amount of each of the plurality of currencies in the equitized currency trust;
processing an electronic order via a computer system received from an Authorized Participant for greater than 50,000 shares in exchange for the plurality of currencies; and
processing an electronic order via a computer system received from the Authorized Participant for redemption of greater than 50,000 shares in exchange for the plurality of currencies.

18. The method of claim 17, wherein the plurality of currencies all correspond to countries belonging to the same continent.

19. The method of claim 17, further comprising selling an option on one or more shares of the equitized currency trust.

20. The method of claim 17, further comprising selling a future on one or more shares of the equitized currency trust.
